(19) United States
(12) Patent Application Publication
(10) Pub. No.: US 2023/0062930 A1
(43) Pub. Date: Mar. 2, 2023

(54) Activating Data Collection

(71) Applicant: Telefonaktiebolaget LM Ericsson (publ), Stockholm (SE)

(72) Inventor: Miguel Angel Puente Pestaña, Madrid (ES)

(21) Appl. No.: 17/793,784

(22) PCT Filed: Mar. 27, 2020
(86) PCT No.: PCT/EP2020/058773

§ 371 Date: Jul. 19, 2022

(30) Foreign Application Priority Data
Jan. 24, 2020 (EP) 20382042.8

(51) Int. Cl. H04W 24/08

(52) U.S. Cl. CPC H04W 24/08

(57) ABSTRACT

A method of activating data collection for an analytic at a first network function comprises registering at the first network function information relating to an analytic, wherein the information relating to the analytic comprises information identifying a user equipment, UE, information identifying the analytic, and at least one analytic criterion that is associated with the analytic (502). The method also involves registering at a second network function the information relating to the analytic (504). The method also involves, at a third network function, receiving initiation information corresponding to the UE, and communicating the initiation information to the second network function (506). The method also involves communicating from the second network function to the third network function, at least a part of the information relating to the analytic, wherein the at least a part of the information relating to the analytic comprises the at least one analytic criterion (508). The method also involves, responsive to the UE meeting the at least one analytic criterion, communicating from the third network function to the first network function a request that data collection be activated for the analytic (510). The method also involves activating data collection for the analytic at the first network function (512).

### FIELD OF THE INVENTION

Embodiments described herein relate to methods and apparatus for activating data collection for an analytic at a first network function.

### BACKGROUND

The Network Data Analytics Function (NWDAF) is an operator managed network analytics logical function that is part of the architecture for the 5G system specified in 3GPP TS 23.501. The NWDAF uses the mechanisms and interfaces specified for the 5th Generation Core Network (5GC) and Operations and Maintenance (OAM).

The NWDAF may interact with different entities for different purposes. For example, the NWDAF may collect data based on event subscription, which may be provided by the Access and Mobility Management Function (AMF), the Session Management Function (SMF), the Policy and Charging Function (PCF), the Unified Data Management (UDM) function, an Application Function (AF) (directly or via the Network Exposure Function (NEF)), and the OAM. The NWDAF may also retrieve information from data repositories (for example, from the Unified Data Repository (UDR) via the Unified Data Management (UDM) function for subscriber-related information. The NWDAF may also retrieve information about Network Functions (NFs) (for example, from the Network Repository Function (NRF) for NF-related information, or from the Network Slice Selection Function (NSSF) for slice-related information). The NWDAF may also provide analytics to consumers on demand. An analytics ID information element may be used to identify the type of supported analytics that a NWDAF can generate.

It will be appreciated that a single instance, or multiple instances, of a NWDAF may be deployed in a PLMN. In the case that multiple NWDAF instances are deployed, the aforementioned architecture supports deploying the NWDAF as a central NF, deploying the NWDAF as a collection of distributed NFs, or deploying the NWDAF as a combination of both of these options. It will also be appreciated that NWDAF instance(s) can be co-located with any NF.

The Data Collection feature permits the NWDAF to retrieve data from various sources (for example, Network Function (NFs) such as AMF, SMF, PCF), and provides a basis for the computation of network analytics. The data which the NWDAF may retrieve includes OAM global NF data, behavior data related to individual UEs or UE groups (for example, UE reachability) per spatial and temporal dimensions (for example per region for a period of time), pre-computed metrics covering UE populations (for example, a number of UEs present in a geographical area) per spatial and temporal dimensions, and other NF data available in the 5th Generation Core (5GC) architecture (for example, NRF).

The NWDAF may retrieve the aforementioned data from the various sources using at least one of the following services: the Generic management services as defined in 3GPP TS 28.532 offered by the OAM in order to collect OAM global NF data, the Exposure services offered by the NFs/AFs in order to retrieve behavior data and other non-OAM pre-computed metrics, and other NF services in order to collect NF data (for example, NRF).

The NWDAF may first obtain information for a UE or a group of UEs in order for the NWDAF to perform the aforementioned data collection. For an analytic, the NWDAF may obtain the corresponding NF type(s) and/or the corresponding event ID(s) and/or the corresponding OAM measurement types for the analytic. The NWDAF shall then determine which NF instance(s) of the relevant NF type(s) are serving the UE or group of UEs, and may optionally take into account the S-NSSAI(s) and area of interest as defined in clause 7.1.3, 3GPP TS 23.501. Following this, the NWDAF invokes Nnf_EventSubscribe services to collect data from the determined NF instance(s), and/or triggers the procedure in clause 6.2.3.2, 3GPP TS 23.501, to subscribe to OAM services in order to collect the OAM measurement. The NWDAF is also able to discover the metrics that are supported by a NF.

It will be appreciated that the data collection procedures enable the NWDAF to efficiently obtain the appropriate data with the appropriate granularity.

On occasion, when a request or subscription for statistics or predictions is received at the NWDAF, the NWDAF may not possess the necessary data to perform the service. For example, data on a monitoring period in the past that corresponds to the observation period is necessary for the provision of statistics and predictions.

Furthermore, for model training, data must be obtained from extended monitoring periods in the past.

Therefore, in order to optimize the service quality, the NWDAF may undertake the following actions. The NWDAF may return a probability assertion as stated in clause 6.1.3, 3GPP TS 23.501, expressing the confidence in the analytics produced at the NWDAF. Where there is zero confidence, no analytics shall be returned by the NWDAF. In the case of subscriptions, the confidence in the analytics is likely to grow over time.

It will be appreciated that the value of the confidence in the analytic will depend on the level or urgency expressed by the time deadline for the analytic to be returned as stated in clause 6.1.3, 3GPP TS 23.501, the level of accuracy of the analytic, and the availability of data at the NWDAF. If insufficient data is collected by the NWDAF to provide an estimation for the requested level of accuracy of the analytic before the time deadline, the NWDAF shall return a zero confidence in the analytic. The NWDAF may wait until enough data is collected before providing a response or a first notification in relation to the analytic.

It will be appreciated that the volume and maximum duration of data storage is a subject of operator configuration. The NWDAF may decide to reduce the amount of data collection in the case of a high signaling load, by either prioritizing requests, reducing the duration of data collection, or reducing the sampling ratios.

Thus, it is specified in 3GPP that the NWDAF may collect data from NFs using the EventExposure mechanism. However, how the NWDAF triggers or activates the data collection is still undefined in 3GPP.

So far, it is considered that NWDAF begins collecting data when an analytics subscription request is received at the NWDAF for a certain analytic. Following the receipt of this request, the NWDAF will then begin collecting the necessary data to produce that analytic.

However, a significant period of time is required for the NWDAF to collect the necessary data in order to produce the analytic. Thus, there is a considerable delay between the receipt of the request for the analytic, and the production of the analytic by the NWDAF.

Furthermore, as the NWDAF only begins to collect data following the receipt of an analytics subscription request, any data that may have contributed to the production of the analytic that was available prior to the receipt of the analytics subscription request will not be collected by the NWDAF, nor used in the produced analytic.

Furthermore, the received analytic subscription request may correspond to a large number of UEs (for example, a group of UEs that are associated with a third party application via the NEF). In this circumstance, a proportion of the group of UEs may not be registered/attached to the network, or may not be executing the application the analytic corresponds to, at the time the analytic subscription request is received at the NWDAF. Therefore, no data will be collected from these UEs by the NWDAF, and there is no mechanism that allows the NWDAF to begin to collect data from these UEs should the UEs register/attach to the network, or start to execute the application that the analytic corresponds to.

Therefore, it may be advantageous to provide methods and apparatus that enable data collection to be handled more efficiently and effectively in a network.

### SUMMARY

According to a first aspect, there is provided a method of activating data collection for an analytic at a first network function. The method comprises registering at the first network function information relating to an analytic, wherein the information relating to the analytic comprises information identifying a user equipment, UE, information identifying the analytic, and at least one analytic criterion that is associated with the analytic. The method also comprises registering at a second network function the information relating to the analytic. The method also comprises, at a third network function, receiving initiation information corresponding to the UE, and communicating the initiation information to the second network function. The method also comprises communicating from the second network function to the third network function, at least a part of the information relating to the analytic, wherein the at least a part of the information relating to the analytic comprises the at least one analytic criterion. The method also comprises, responsive to the UE meeting the at least one analytic criterion, communicating from the third network function to the first network function a request that data collection be activated for the analytic. The method also comprises activating data collection for the analytic at the first network function.

The method may further comprise, responsive to the UE no longer meeting the at least one analytic criterion, communicating from the third network function to the first network function a request that data collection be deactivated for the analytic. The method may further comprise deactivating data collection for the analytic at the first network function.

The request that data collection be activated for the analytic may further comprise the information relating to the analytic.

The information relating to the analytic may be received from a network server comprising an application function, AF.

The information relating to the analytic may be received as part of a subscription request.

The first network function may comprise a network function for network data analytics, NWDAF.

The second network function may comprise a network function for storing subscription data, UDR.

The at least one analytic criterion may comprise a location identifier.

The third network function may comprise a network function for access and mobility management, AMF.

The at least one analytic criterion may comprise an application identifier.

The third network function may comprise a network function for session management, SMF.

The initiation information corresponding to the UE may comprise information identifying the UE.

The step of registering at the second network function the information relating to the analytic may comprise receiving at a network exposure function, NEF, the information relating to the analytic, communicating from the network exposure function the information relating to the analytic, to the second network function, and registering at the second network function the information relating to the analytic.

The step of registering at the second network function the information relating to the analytic may comprise receiving at a network exposure function, NEF, the information relating to the analytic, communicating the information relating to the analytic from the network exposure function to the first network function, communicating the information relating to the analytic from the first network function to the second network function, and registering at the second network function the information relating to the analytic.

According to another aspect, there is provided a system for activating data collection for an analytic at a first network function. The system comprises a first network function, a second network function, and a third network function. The system is configured to perform a method according to the first aspect.

According to a further aspect, there is provided a computer program product, comprising computer readable code for causing a suitable programmed processor to perform a method according to the first aspect.

According to a still further aspect, there is provided a computer program product, comprising a tangible computer readable medium, containing computer readable instructions for causing a processor to perform a method. The method comprises registering at the first network function information relating to an analytic, wherein the information relating to the analytic comprises information identifying a user equipment, UE, information identifying the analytic, and at least one analytic criterion that is associated with the analytic. The method also comprises registering at a second network function the information relating to the analytic. The method also comprises, at a third network function, receiving initiation information corresponding to the UE, and communicating the initiation information to the second network function. The method also comprises communicating from the second network function to the third network function, at least a part of the information relating to the analytic, wherein the at least a part of the information relating to the analytic comprises the at least one analytic criterion. The method also comprises, responsive to the UE meeting the at least one analytic criterion, communicating from the third network function to the first network function a request that data collection be activated for the analytic. The method also comprises activating data collection for the analytic at the first network function.

According to a second aspect, there is provided a method of activating data collection for an analytic at a first network function. The method comprises registering information relating to an analytic, wherein the information relating to the analytic comprises information identifying a user equipment, UE, information identifying the analytic, and at least one analytic criterion that is associated with the analytic. The method also comprises receiving, from a third network function, a request that data collection be activated for the analytic. The method also comprises activating data collection for the analytic.

The method may comprise receiving, from the third network function, a request that data collection be deactivated for the analytic. The method may also comprise deactivating data collection for the analytic.

The request that data collection be activated for the analytic may further comprise the information relating to the analytic.

The method may further comprise receiving, from a network server comprising an application function, AF, the information relating to the analytic.

The information relating to the analytic may be received as part of a subscription request.

The first network function may comprise a network function for network data analytics, NWDAF.

Where the method comprises registering at a second network function the information relating to the analytic, the second network function may comprise a network function for storing subscription data, UDR.

The at least one analytic criterion may comprise a location identifier.

The third network function may comprise a network function for access and mobility management, AMF.

The at least one analytic criterion may comprise an application identifier.

The third network function may comprise a network function for session management, SMF.

The method may further comprise communicating the information relating to the analytic to the second network function.

According to another aspect, there is provided a network node for activating data collection for an analytic at a first network function. The network node comprises an interface configured for allowing communication with other network nodes, a memory, and a processor. The network node is configured to perform a method according to the second aspect.

According to a further aspect, there is provided a computer program product, comprising computer readable code, configured for causing a suitable programmed processor to perform a method according to the second aspect.

According to a still further aspect, there is provided a computer program product, comprising a tangible computer readable medium, containing computer readable instructions for causing a processor to perform a method. The method comprises registering information relating to an analytic, wherein the information relating to the analytic comprises information identifying a user equipment, UE, information identifying the analytic, and at least one analytic criterion that is associated with the analytic. The method also comprises receiving, from a third network function, a request that data collection be activated for the analytic. The method also comprises activating data collection for the analytic.

According to a third aspect, there is provided a method of operation of a second network function. The method comprises registering information relating to an analytic, wherein the information relating to the analytic comprises information identifying a user equipment, UE, information identifying the analytic, and at least one analytic criterion that is associated with the analytic. The method also comprises receiving, from a third network function, initiation information corresponding to the UE. The method also comprises communicating, to the third network function, at least a part of the information relating to the analytic, wherein the at least a part of the information relating to the analytic comprises the at least one analytic criterion.

The second network function may comprise a network function for storing subscription data, UDR.

The at least one analytic criterion may comprise a location identifier.

The third network function may comprise a network function for access and mobility management, AMF.

The at least one analytic criterion may comprise an application identifier.

The third network function may comprise a network function for session management, SMF.

The initiation information corresponding to the UE may comprise the information identifying the UE.

The step of registering the information relating to the analytic may comprise receiving from a network function for network exposure, NEF, the information relating to the analytic. The step may also comprise registering the information relating to the analytic.

The step of registering the information relating to the analytic may comprise receiving from a first network function the information relating to the analytic. The step may also comprise registering the information relating to the analytic.

The first network function may comprise a network function for network data analytics, NWDAF.

According to another aspect, there is provided a network node for operation of a second network function. The network node comprises an interface configured for allowing communication with other network nodes, a memory, and a processor. The network node is configured to perform a method according to the third aspect.

According to a further aspect, there is provided a computer program product, comprising computer readable code, configured for causing a suitable programmed processor to perform a method according to the third aspect.

According to a still further aspect, there is provided a computer program product, comprising a tangible computer readable medium, containing computer readable instructions for causing a processor to perform a method. The method comprises registering information relating to an analytic, wherein the information relating to the analytic comprises information identifying a user equipment, UE, information identifying the analytic, and at least one analytic criterion that is associated with the analytic. The method also comprises receiving, from a third network function, initiation information corresponding to the UE. The method also comprises communicating, to the third network function, at least a part of the information relating to the analytic, wherein the at least a part of the information relating to the analytic comprises the at least one analytic criterion.

According to a fourth aspect, there is provided a method of operation of a third network function. The method comprises receiving initiation information corresponding to a UE. The method also comprises communicating the initiation information to a second network function. The method also comprises receiving from the second network function, at least a part of information relating to the analytic, wherein the information relating to the analytic comprises information identifying the UE, information identifying the analytic, and at least one analytic criterion that is associated with the analytic, and wherein the at least a part of the information relating to the analytic comprises the at least one analytic criterion. The method also comprises responsive to the UE meeting the at least one analytic criterion, communicating to a first network function a request that data collection be activated for the analytic.

The method may further comprise responsive to the UE no longer meeting the at least one analytic criterion, communicating to the first network function a request that data collection be deactivated for the analytic.

The request that data collection be activated for the analytic may further comprise the information relating to the analytic.

The first network function may comprise a network function for network data analytics, NWDAF.

The second network function may comprise a network function for storing user subscription data, UDR.

The at least one analytic criterion may comprise a location identifier.

The third network function may comprise a network function for access and mobility management, AMF.

The at least one analytic criterion may comprise an application identifier.

The third network function may comprise a network function for session management, SMF.

The initiation information corresponding to the UE may comprise the information identifying the UE.

According to another aspect, there is provided a network node for the operation of a third network function. The network node comprises an interface configured for allowing communication with other network nodes, a memory, and a processor. The network node is configured to perform a method according to the fourth aspect.

According to a further aspect, there is provided a computer program product, comprising computer readable code, configured for causing a suitable programmed processor to perform a method according to the fourth aspect.

According to a still further aspect, there is provided a computer program product, comprising a tangible computer readable medium, containing computer readable instructions for causing a processor to perform a method. The method comprises receiving initiation information corresponding to a UE. The method also comprises communicating the initiation information to a second network function. The method also comprises receiving from the second network function, at least a part of information relating to the analytic, wherein the information relating to the analytic comprises information identifying the UE, information identifying the analytic, and at least one analytic criterion that is associated with the analytic, and wherein the at least a part of the information relating to the analytic comprises the at least one analytic criterion. The method also comprises, responsive to the UE meeting the at least one analytic criterion, communicating to a first network function a request that data collection be activated for the analytic.

### BRIEF DESCRIPTION OF THE DRAWINGS

FIGS. 1 and 2 are block schematic diagrams of a network architecture;

FIG. 3 is a block schematic diagram of he Network Data Analytics Exposure architecture;

FIGS. 4(a), 4(b), and 4(c) are block schematic diagrams of network nodes;

FIG. 5 is flow chart illustrating a method of activating data collection for an analytic at a first network function;

FIG. 6 is flow chart illustrating a method of activating data collection for an analytic at a first network function;

FIG. 7 is flow chart illustrating a method of operation of a second network function;

FIG. 8 is flow chart illustrating a method of operation of a third network function; and

FIGS. 9, 10 and 11 are signaling diagrams.

### DETAILED DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

The following sets forth specific details, such as particular embodiments for purposes of explanation and not limitation. But it will be appreciated by one skilled in the art that other embodiments may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

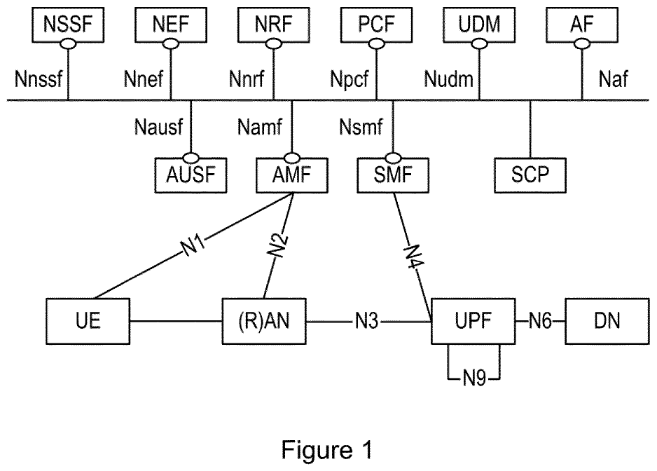

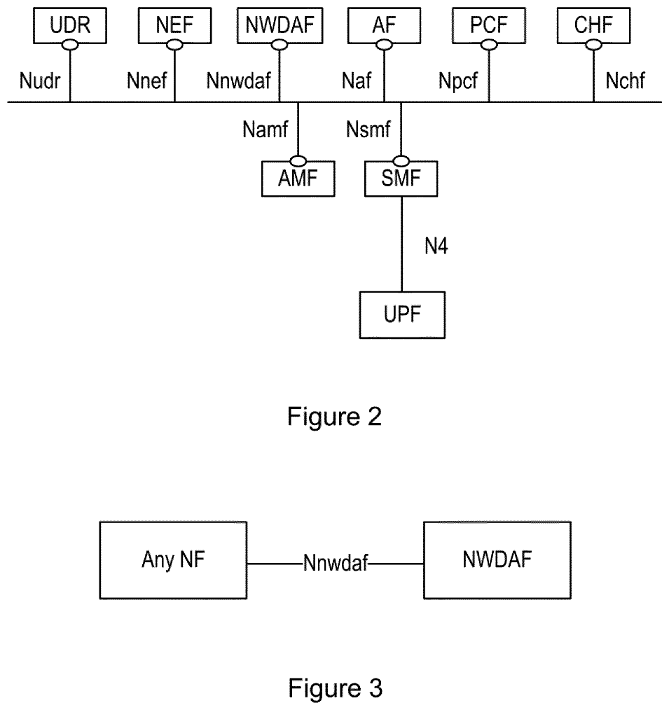

FIG. 1 illustrates a 5G mobile communications network architecture, as defined in the 3GPP TS 23.501 v15.3.0. FIG. 2 illustrates the 3GPP 5G Core (5GC) architecture for policy, charging and analytics. In FIG. 2, service based interfaces are represented in the format “Nxyz”, and point to point interfaces are illustrated in the format “Nx”.

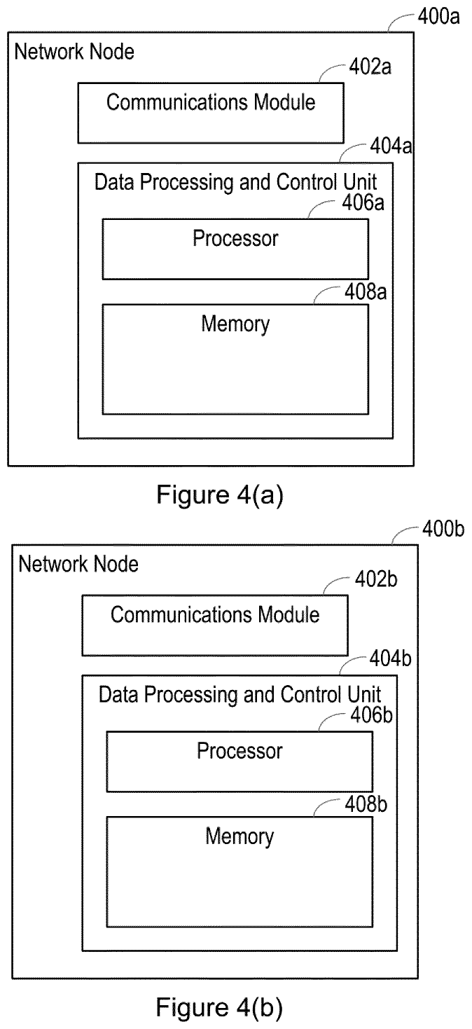

FIG. 3 illustrates the Network Data Analytics Exposure architecture. The NWDAF may communicate with any network function (NF) via the Nnwdaf interface.

The architecture illustrated in FIG. 1 has service-based interfaces in the control plane, implying that the interaction of the network functions is done by means of services. The network functions in the 5G control plane provide services that are consumed by other network functions in the 5G control plane.

The most relevant functional elements as illustrated in FIGS. 1 and 2 for the purposes of understanding this disclosure are the following:

The AF (Application Function) may interact with the 3GPP Core Network to exchange information with the network operator.

The NEF (Network Exposure Function) translates between information exchanged with the external Application Function (AF) and information exchanged with the internal network function(s). It is the Operator Network entry point for Application Service Providers (ASPs), such that an external AF interacts with the 3GPP Core Network through the NEF. This is a unique way of creating an interactive relationship between the service providers and network operators.

The PCF (Policy Control Function) supports a unified policy framework to govern the behaviour of the network, and may provide PCC (Policy and Charging Control) rules to the SMF (Session Management Function). It also implements a Front End (PCF FE) to access subscription information relevant for policy decisions in a Unified Data Repository (UDR). The PCF provides PCC (Policy and Charging Control) to the Policy and Charging Enforcement Function (PCEF) (SMF/UPF that enforces policy and charging decisions according to the PCCs.

The SMF (Session Management Function) is responsible for Session establishment, modification and release, including selection and control of the UPF entities (for example, for event reporting). The SMF can provide to the UPF information related to classification information obtained e.g. from the NEF, for the service classification of the user IP data. The SMF interacts with the UPF over N4 Reference point using Packet Forwarding Control Protocol (PFCP) procedures.

The AMF (Access and Mobility Management Function) is responsible for dealing with issues relating to the mobility of a user, i.e. a User Equipment (UE) device.

The UPF (User Plane Function) handles the user data traffic (for example, based on rules received from the SMF) and optionally includes Deep Packet Inspection (DPI) functionality, which comprises inspecting and analysing the contents of the IP data packets beyond the so-called IP 5 tuples. The IP 5 tuples consist of the heading elements of an IP data packet comprising: IP source address, IP destination address, source transport address, destination transport address, and protocol over IP (e.g. TCP, UDP). The SMF may also support different enforcement actions, for example, event detection and reporting.

The UDR (Unified Data Repository), not shown in FIG. 1, provides storage and retrieval of subscription data by the UDM (Unified Data Management, which is the evolution of Home Subscriber Server (HSS) in the 5G architecture), storage and retrieval of policy data by the PCF and storage and retrieval of structured data for exposure, and application data (including Packet Flow Descriptions (PFDs) for application detection, application request information for multiple UEs), by the NEF.

The NWDAF (Network Data Analytics Function), not shown in FIG. 1, is also part of the architecture specified in TS 23.501, and uses the mechanisms and interfaces specified for 5GC and OAM.

The NWDAF may interact with different entities for different purposes. For example, the NWDAF may collect data based on event subscription, which may be provided by the AMF, the SMF, the PCF, the UDM (Unified Data Management), the AF (directly or via the NEF), and the OAM. The NWDAF may also retrieve information from data repositories (for example, from the UDR (Unified Data Repository) via the UDM for subscriber-related information. The NWDAF may also retrieve information about NFs (for example, from the NRF (Network Repository Meeting) for NF-related information, from the NSSF (Network Slice Selection Function) for slice-related information). The NWDAF may also provide analytics to consumers on demand.

Methods are described herein, in which data collection for an analytic may be activated at a first network function prior to the receipt of an analytic subscription request relating to the analytic. Thus, methods described herein may allow for the data collection for an analytic to be configured and executed prior to the receipt of an analytic subscription request relating to the analytic, for one or more UEs that are associated with the analytic.

The further description herein relates to embodiments in which the method is performed in a 5G network architecture as shown in FIG. 1.

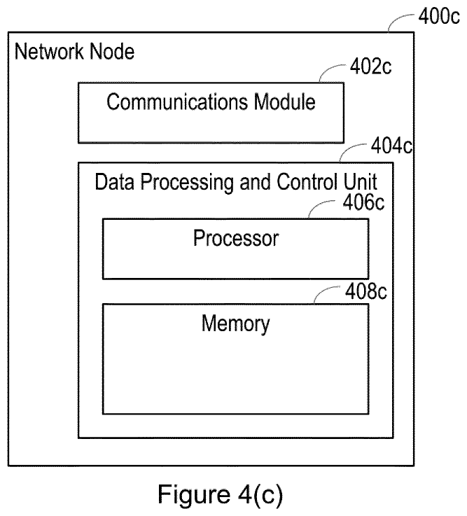

FIG. 4(a) is a block schematic diagram of a network node 400a, more specifically a network node for a Network Data Analytics Function (NWDAF).

The network node 400a comprises a communications module 402a and a data processing and control unit 404a.

The communications module 402a is configured for communication using any required communications protocol, for example with other nodes of the architecture shown in FIG. 1.

The data processing and control unit 404a comprises a processor 406a and a memory 408a. The memory 408a is configured for storing working data as required, and also for storing program instructions, and the processor 406a is configured for performing data processing and logical operations on the basis of program instructions stored in the memory 408a. More specifically, the processor 406a may be programmed to perform the methods described herein. Although shown as respective single units, the processor 406a and the memory 408a may be implemented as multiple units, each carrying out a respective part of the required functionality.

FIG. 4(b) is a block schematic diagram of a network node 400b, more specifically a network node for a Network Function (NF), for example a UDR network node in the architecture of FIG. 1.

The network node 400b comprises a communications module 402b and a data processing and control unit 404b.

The communications module 402b is configured for communication using any required communications protocol, for example with other nodes of the architecture shown in FIG. 1.

The data processing and control unit 404b comprises a processor 406b and a memory 408b. The memory 408b is configured for storing working data as required, and also for storing program instructions, and the processor 406b is configured for performing data processing and logical operations on the basis of program instructions stored in the memory 408b. More specifically, the processor 406b may be programmed to perform the methods described herein. Although shown as respective single units, the processor 406b and the memory 408b may be implemented as multiple units, each carrying out a respective part of the required functionality.

FIG. 4(c) is a block schematic diagram of a network node 400c, more specifically a network node for a Network Function (NF), for example an AMF network node, or a SMF network node in the architecture of FIG. 1.

The network node 400c comprises a communications module 402c and a data processing and control unit 404c.

The communications module 402c is configured for communication using any required communications protocol, for example with other nodes of the architecture shown in FIG. 1.

The data processing and control unit 404c comprises a processor 406c and a memory 408c. The memory 408c is configured for storing working data as required, and also for storing program instructions, and the processor 406c is configured for performing data processing and logical operations on the basis of program instructions stored in the memory 408c. More specifically, the processor 406c may be programmed to perform the methods described herein. Although shown as respective single units, the processor 406c and the memory 408c may be implemented as multiple units, each carrying out a respective part of the required functionality.

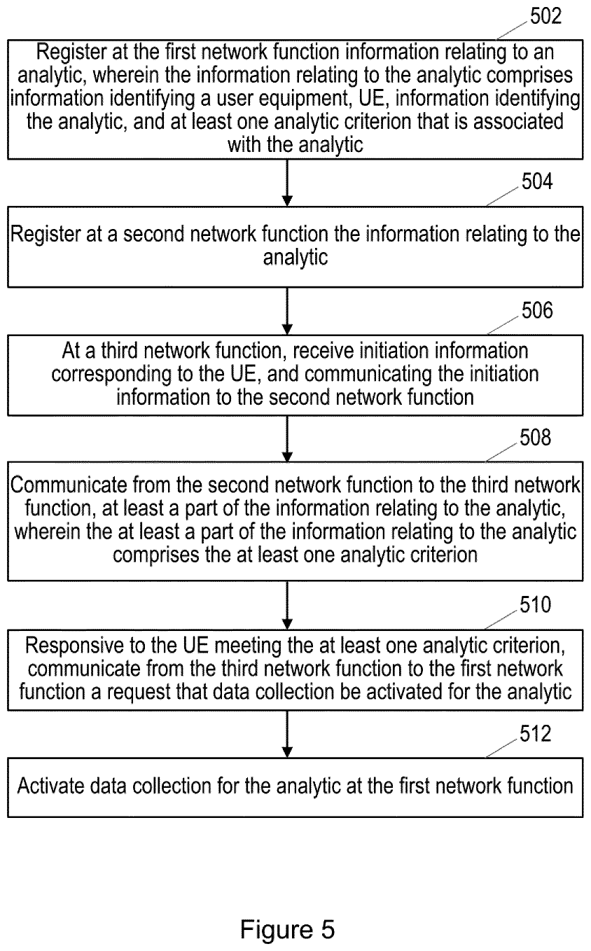

FIG. 5 is a flow chart, illustrating a method 500 of activating data collection for an analytic at a first network function. The method 500 may be executed by a plurality of network nodes in the architecture of FIG. 1, for example, the network nodes 400a, 400b, and 400c.

The method 500 comprises, at step 502, registering at the first network function information relating to an analytic, wherein the information relating to the analytic comprises information identifying a user equipment, UE, information identifying the analytic, and at least one analytic criterion that is associated with the analytic.

In some embodiments, the first network function may comprise a network function for network data analytics, NWDAF.

In some embodiments, the information relating to the analytic is received from a network server comprising an application function, AF. In some embodiments, the information relating to the analytic may be received as part of a subscription request.

The application function may comprise a third party application function. For example, in some embodiments, a third party application function (for example, Uber) may wish to track the mobility pattern of its users, such that it can optimize the routes and locations of the cars within a certain city. In this example, the third party application function requests that the operator track the mobility pattern (in other words, the analytic) for the users (in other words, the user equipment) of the application in a certain city (in other words, the at least one analytic criterion).

At step 504, the method comprises registering at a second network function the information relating to the analytic.

In some embodiments, the second network function may comprise a network function for storing subscription data, UDR.

In other words, the information identifying the user equipment, the information identifying the analytic, and at least one analytic criterion that is associated with the analytic are stored at the UDR, as part of the relevant subscription information for the UE that is associated with the analytic. It will be appreciated that more than one analytic may be associated with the UE, and thus information identifying one or more analytics may be stored at the UDR as part of the relevant subscription information for the UE.

It will be also be appreciated that this information shall be stored at the second network function for each UE that corresponds to the analytic.

In some embodiments, the at least one analytic criterion comprises a location identifier. The location identifier may comprise any one of: a location name, a list of tracking areas comprised within a relevant location, a list of base stations comprised with a relevant location, geographical coordinates, for example. The location identifier may correspond to a location that is associated with the analytic.

In some embodiments, the at least one analytic criterion comprises an application identifier. The application identifier may correspond to a third party application that is associated with the analytic.

In other words, the at least one analytic criterion that is stored at the UDR indicates under what conditions the data collection for the analytic shall be activated/deactivated. For example, where the at least one analytic criterion that is stored comprises a location identifier, data collection for the analytic may be activated when it is determined that the UE has entered that location. Additionally or alternatively, where the at least one analytic criterion that is stored comprises an application identifier, data collection for the analytic may be activated when it is determined that the UE is executing that application.

In some embodiments, the step of registering at the second network function the information relating to the analytic may comprise the steps of receiving at a network exposure function, NEF, the information relating to the analytic, communicating from the network exposure function the information relating to the analytic, to the second network function, and registering at the second network function the information relating to the analytic.

In some embodiments, the step of registering at the second network function the information relating to the analytic may comprise the steps of receiving at a network exposure function, NEF, the information relating to the analytic, communicating the information relating to the analytic from the network exposure function to the first network function, communicating the information relating to the analytic from the first network function to the second network function, and registering at the second network function the information relating to the analytic.

At step 506, the method comprises, at a third network function, receiving initiation information corresponding to the UE, and communicating the initiation information to the second network function.

In some embodiments, the initiation information corresponding to the UE may be received in a UE registration procedure, or in a PDU establishment procedure. It will be appreciated that these procedures will be executed on a per UE basis. In other words, regardless of whether the second network function registers information relating to an analytic that corresponds to one or more UEs, the UE registration procedure, or the PDU establishment procedure will be executed for each of the UEs that correspond to the analytic individually.

In some embodiments, the third network function may comprise a network function for access and mobility management, AMF. It will be appreciated that the third network function may comprise the AMF when the at least one analytic criterion comprises a location identifier.

In some embodiments, the third network function comprises a network function for session management, SMF. It will be appreciated that the third network function may comprise the SMF when the at least one analytic criterion comprises an application identifier.

At step 508, the method comprises communicating from the second network function to the third network function, at least a part of the information relating to the analytic, wherein the at least a part of the information relating to the analytic comprises the at least one analytic criterion.

In some embodiments, the initiation information corresponding to the UE may comprise information identifying the UE.

At step 510, the method comprises, responsive to the UE meeting the at least one analytic criterion, communicating from the third network function to the first network function a request that data collection be activated for the analytic. For example, the request that data collection be activated for the analytic may be communicated following the determination that the UE has executed the application associated with the analytic, that corresponds to the at least one analytic criterion. Additionally or alternatively, the request that data collection be activated for the analytic may be communicated following the determination that the UE has entered the location associated with the analytic, that corresponds to the at least one analytic criterion.

In some embodiments, the request that data collection be activated for the analytic may further comprise the information relating to the analytic.

At step 512, the method comprises activating data collection for the analytic at the first network function.

In some embodiments, the method may further comprise the steps of, responsive to the UE no longer meeting the at least one analytic criterion, communicating from the third network function to the first network function a request that data collection be deactivated for the analytic, and deactivating data collection for the analytic at the first network function.

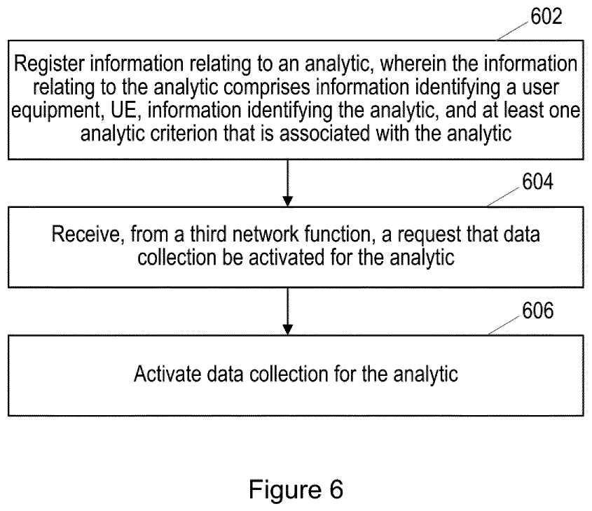

FIG. 6 is a flow chart, illustrating a method 600 of activating data collection for an analytic at a first network function. The method 600 may be executed by a network node in the architecture of FIG. 1, for example, the network node 400a.

The method 600 comprises, at step 602, registering information relating to an analytic, wherein the information relating to the analytic comprises information identifying a user equipment, UE, information identifying the analytic, and at least one analytic criterion that is associated with the analytic.

In some embodiments, the first network function comprises a network function for network data analytics, NWDAF.

In some embodiments, the at least one analytic criterion comprises a location identifier. The location identifier may comprise any one of: a location name, a list of tracking areas comprised within a relevant location, a list of base stations comprised with a relevant location, geographical coordinates, for example. The location identifier may correspond to a location that is associated with the analytic.

In some embodiments, the at least one analytic criterion comprises an application identifier. The application identifier may correspond to a third party application that is associated with the analytic.

At step 604, the method comprises receiving, from a third network function, a request that data collection be activated for the analytic.

In some embodiments, the request that data collection be activated for the analytic may further comprise the information relating to the analytic.

In some embodiments, the third network function may comprise a network function for access and mobility management, AMF. It will be appreciated that the third network function may comprise the AMF when the at least one analytic criterion comprises a location identifier.

In some embodiments, the third network function comprises a network function for session management, SMF. It will be appreciated that the third network function may comprise the SMF when the at least one analytic criterion comprises an application identifier.

At step 606, the method comprises activating data collection for the analytic.

In some embodiments, the method 600 may further comprise the steps of receiving, from the third network function, a request that data collection be deactivated for the analytic, and deactivating data collection for the analytic.

In some embodiments, the method 600 may further comprise the step of receiving, from a network server comprising an application function, AF, the information relating to the analytic. In some embodiments, the information relating to the analytic is received as part of a subscription request.

The application function may comprise a third party application function. For example, in some embodiments, a third party application function (for example, Uber) may wish to track the mobility pattern of its users, such that it can optimize the routes and locations of the cars within a certain city. In this example, the third party application function requests that the operator track the mobility pattern (in other words, the analytic) for the users (in other words, the user equipment) of the application in a certain city (in other words, the at least one analytic criterion).

In some embodiments, the method 600 may further comprise the step of communicating the information relating to the analytic to the second network function.

In some embodiments, the second network function comprises a network function for storing subscription data, UDR.

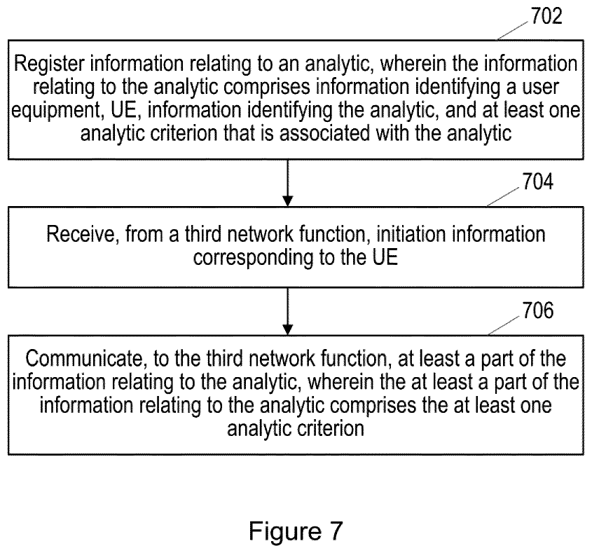

FIG. 7 is a flow chart, illustrating a method 700 of operation of a second network function. The method 700 may be executed by a network node in the architecture of FIG. 1, for example, the network node 400b.

The method 700 comprises, at step 702, registering information relating to an analytic, wherein the information relating to the analytic comprises information identifying a user equipment, UE, information identifying the analytic, and at least one analytic criterion that is associated with the analytic.

In some embodiments, the second network function comprises a network function for storing subscription data, UDR.

In some embodiments, the at least one analytic criterion comprises a location identifier. The location identifier may comprise any one of: a location name, a list of tracking areas comprised within a relevant location, a list of base stations comprised with a relevant location, geographical coordinates, for example. The location identifier may correspond to a location that is associated with the analytic.

In some embodiments, the at least one analytic criterion comprises an application identifier. The application identifier may correspond to a third party application that is associated with the analytic.

In some embodiments, the step of registering the information relating to the analytic may comprise receiving from a network function for network exposure, NEF, the information relating to the analytic, and registering the information relating to the analytic.

In some embodiments, the step of registering the information relating to the analytic may comprise receiving from a first network function the information relating to the analytic, and registering the information relating to the analytic

In some embodiments, the first network function may comprise a network function for network data analytics, NWDAF.

At step 704, the method comprises receiving, from a third network function, initiation information corresponding to the UE.

In some embodiments, the initiation information corresponding to the UE comprises the information identifying the UE.

At step 706, the method comprises communicating, to the third network function, at least a part of the information relating to the analytic, wherein the at least a part of the information relating to the analytic comprises the at least one analytic criterion.

The third network function may comprise a network function for access and mobility management, AMF, when the at least one analytic criterion comprises a location identifier. The third network function may comprise a network function for session management, SMF, when the at least one analytic criterion comprises an application identifier.

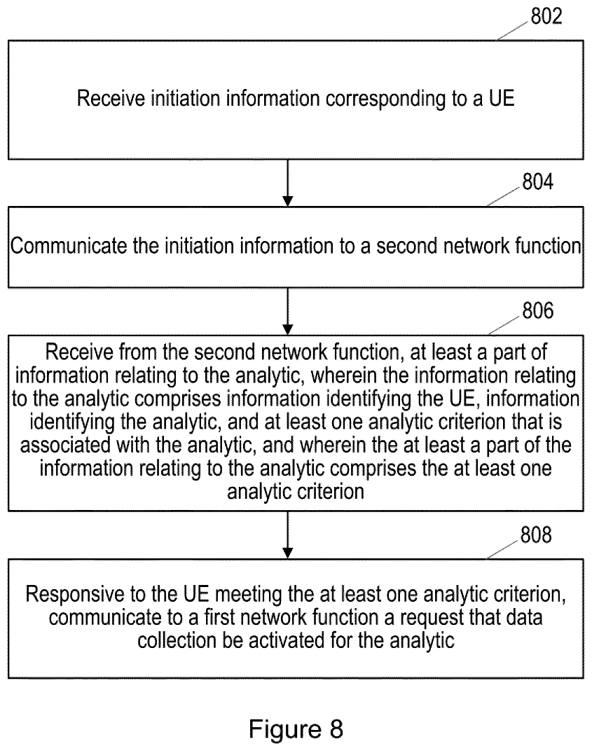

FIG. 8 is a flow chart, illustrating a method 800 of operation of a third network function. The method 800 may be executed by a network node in the architecture of FIG. 1, for example, the network node 400c.

The method 800 comprises, at step 802, receiving initiation information corresponding to a UE.

In some embodiments, the initiation information corresponding to the UE comprises the information identifying the UE.

At step 804, the method comprises communicating the initiation information to a second network function.

In some embodiments, the second network function comprises a network function for storing user subscription data, UDR.

At step 806, the method comprises receiving from the second network function, at least a part of information relating to the analytic, wherein the information relating to the analytic comprises information identifying the UE, information identifying the analytic, and at least one analytic criterion that is associated with the analytic, and wherein the at least a part of the information relating to the analytic comprises the at least one analytic criterion.

In some embodiments, the at least one analytic criterion comprises a location identifier. The location identifier may comprise any one of: a location name, a list of tracking areas comprised within a relevant location, a list of base stations comprised with a relevant location, geographical coordinates, for example. The location identifier may correspond to a location that is associated with the analytic.

In some embodiments, the at least one analytic criterion comprises an application identifier. The application identifier may correspond to a third party application that is associated with the analytic.

In some embodiments, the third network function may comprise a network function for access and mobility management, AMF. It will be appreciated that the third network function may comprise the AMF when the at least one analytic criterion comprises a location identifier.

In some embodiments, the third network function comprises a network function for session management, SMF. It will be appreciated that the third network function may comprise the SMF when the at least one analytic criterion comprises an application identifier.

At step 808, the method comprises, responsive to the UE meeting the at least one analytic criterion, communicating to a first network function a request that data collection be activated for the analytic.

In some embodiments, the first network function may comprise a network function for network data analytics, NWDAF

In some embodiments, the request that data collection be activated for the analytic may further comprise the information relating to the analytic.

In some embodiments, the method further comprises the step of, responsive to the UE no longer meeting the at least one analytic criterion, communicating to the first network function a request that data collection be deactivated for the analytic.

As noted above, the methods described herein may allow for the data collection for an analytic to be configured and executed prior to the receipt of an analytic subscription request relating to the analytic, for one or more users that are associated with the analytic. Furthermore, the methods described herein may allow a network operator (and/or the NWDAF) to respond to a received analytic subscription request more quickly, as the data contributing to the production of the analytic has already been collected by the NWDAF prior to the receipt of the analytic subscription request.

Furthermore, as the aforementioned process allows the UEs that are associated with the analytic to be initialized prior to the receipt of an analytics subscription request, no data contributing to the production the analytic that is generated and/or obtained by these UEs is lost, as the method allows for this data to be collected in response to the UE fulfilling at least one analytic criterion that is associated with the analytic. In other words, when the data contributing to the production the analytic becomes available in the network, even prior to the receipt of an analytic subscription request, this data may then be collected by the NWDAF.

This initialization process also enables UEs that are associated with the analytic, but that are not currently fulfilling the at least one analytic criterion to be configured to enable data collection at the NWDAF should they fulfil the at least one analytic criterion. It will be appreciated that, when data is collected by the NWDAF in response to the receipt of an analytics subscription request, data will only be collected from the UEs that are associated with the analytic and currently fulfilling the at least one analytic criterion. There is no mechanism by which UEs that are associated with the analytic, but that are not currently fulfilling the at least one analytic criterion may be initialized such that data may be collected from them should the at least one analytic criterion be met in response to the receipt of an analytics subscription request. As a result of this, when an analytics subscription request is received at the NWDAF, the NWDAF is required to execute necessary processes to check whether a UE associated with the analytic has fulfilled the at least one analytic criterion.

However, as a result of the initialization process described herein, the NWDAF is notified when a UE that is associated with the analytic fulfils (or stops fulfilling) at least one analytic criterion that is associated with the analytic. Thus, the signaling and processing load at the NWDAF may be reduced (as the aforementioned “checking” by the NWDAF is no longer necessary) and thus NWDAF efficiency may be improved.

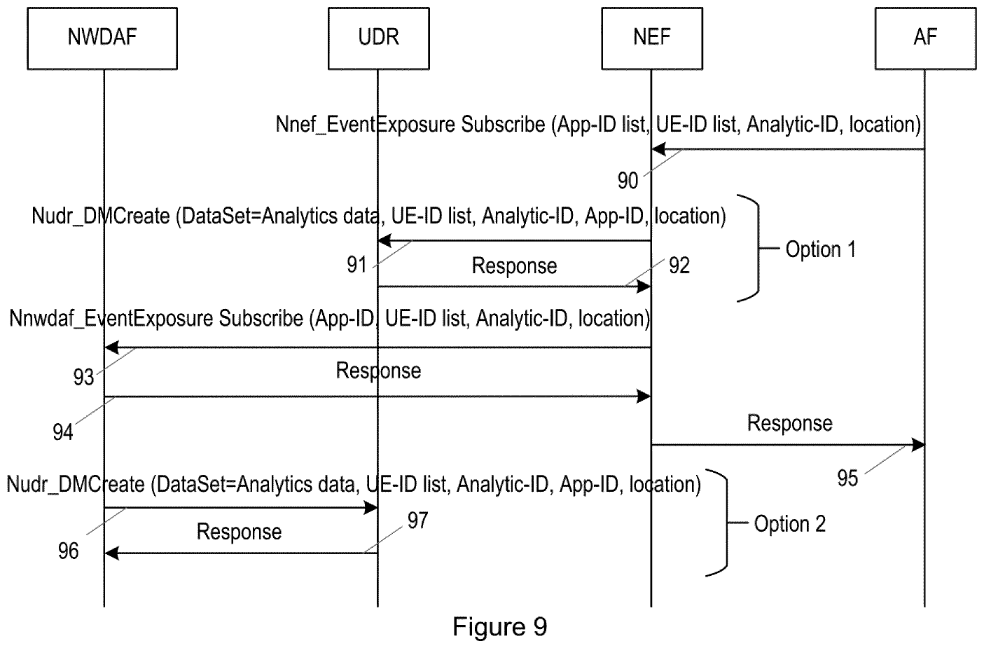

FIG. 9 is a signaling diagram, illustrating example steps in a method that comprises registering at a first network function information relating to an analytic, wherein the information relating to the analytic comprises information identifying a user equipment, UE, information identifying the analytic, and at least one analytic criterion that is associated with the analytic, and registering at a second network function the information relating to the analytic.

In this illustrated example, the registration process is initiated by a third party application function (for example, Uber). However, it will be appreciated that the process may be initiated by any suitable application function.

At step 90, an application function associated with a specific third party application (for example, Uber) invokes the Nnef_EventExposure Subscribe service operation in the NEF, wherein the request comprises information identifying one or more user equipments (UE-ID list), information identifying the analytic (Analytic-ID), and at least one analytic criterion that is associated with the analytic (Location). In other words, the request comprises information relating to the analytic. In this illustrated example, the request further comprises information identifying the application function (App-ID).

The information identifying the one or more UEs may for example be a list of users of the third party application. Thus, the third party application can request information about the users of that application. For example, the third party application can request information about the mobility of users of that application.

In some embodiments, the at least one analytic criterion that is associated with the analytic may comprise a location identifier. This may be the case where the analytic relates in some way to the actions of the users of the application function when in a particular location, for example. Additionally or alternatively, the at least one analytic criterion may comprise an application identifier. This may be the case where the analytic relates in some way to the execution of the application function by the users of the application function, for example.

It will be appreciated that, where the at least one analytic criterion comprises a location identifier, the location identifier may comprise any one of: a location name, a list of tracking areas comprised within a relevant location, a list of base stations comprised with a relevant location, geographical coordinates, for example.

The information relating to the analytic that is received at the NEF in step 90 may then be registered at the first network function according to one of two methods.

According to the first method, at step 91, the NEF registers the information relating to the analytic in the UDR by invoking the Nudr_DMCreate service operation. In this illustrated example, the Nudr_DMCreate service operation comprises the information identifying the one or more user equipment (UE-ID list), information identifying the analytic (Analytic-ID), and at least one analytic criterion that is associated with the analytic (Location). In other words, the information relating to the analytic is registered at a second network function.

In this illustrated example, the Nudr_DMCreate service operation further comprises information identifying the application function (App-ID), and information identifying the relevant analytics data set that is to be collected and stored at the UDR (DataSet=Analytics data).

At step 92, the UDR acknowledges the registration to the NEF.

At step 93, the NEF relays the subscription request that was communicated to the NEF in step 91 to the NWDAF. This request comprises information identifying the one or more user equipment (UE-ID list), information identifying the analytic (Analytic-ID), and at least one analytic criterion that is associated with the analytic (Location). In other words, the information relating to the analytic is registered at a first network function. In this illustrated example, the request further comprises information identifying the application function (App-ID).

At step 94, the NWDAF acknowledges the registration to the NEF.

At step 95, the NEF acknowledges the subscription request (that was received at step 90) to the AF.

Alternatively, according to the second method, steps 91 and 92 do not occur. Rather, step 90 is directly followed by step 93.

At step 93, the NEF communicates a subscription request to the NWDAF. This request comprises information identifying one or more user equipment (UE-ID list), information identifying the analytic (Analytic-ID), and at least one analytic criterion that is associated with the analytic (Location). In other words, the information relating to the analytic is registered at a first network function. In this illustrated example, the request further comprises information identifying the application function (App-ID).

At step 94, the NWDAF acknowledges the registration to the NEF.

At step 95, the NEF acknowledges the subscription request (that was received at step 90) to the AF.

Following step 95 (when the second method is being executed), at step 96, the NWDAF registers the information relating to the analytic in the UDR by invoking the Nudr_DMCreate service operation. In this illustrated example, the Nudr_DMCreate service operation comprises the information identifying one or more user equipment (UE-ID list), information identifying the analytic (Analytic-ID), and at least one analytic criterion that is associated with the analytic (Location). In other words, the information relating to the analytic is registered at a second network function.

In this illustrated example, the Nudr_DMCreate service operation further comprises information identifying the application function (App-ID), and information identifying the relevant analytics data set that is to be collected and stored at the UDR

(DataSet=Analytics data).

At step 97, the UDR acknowledges the registration request received at step 96.

In other words, the UDR may obtain the information described above as part of the UE subscription data (either manually, or via an OAM process), or alternatively, the information may be registered in the UDR by a network function.

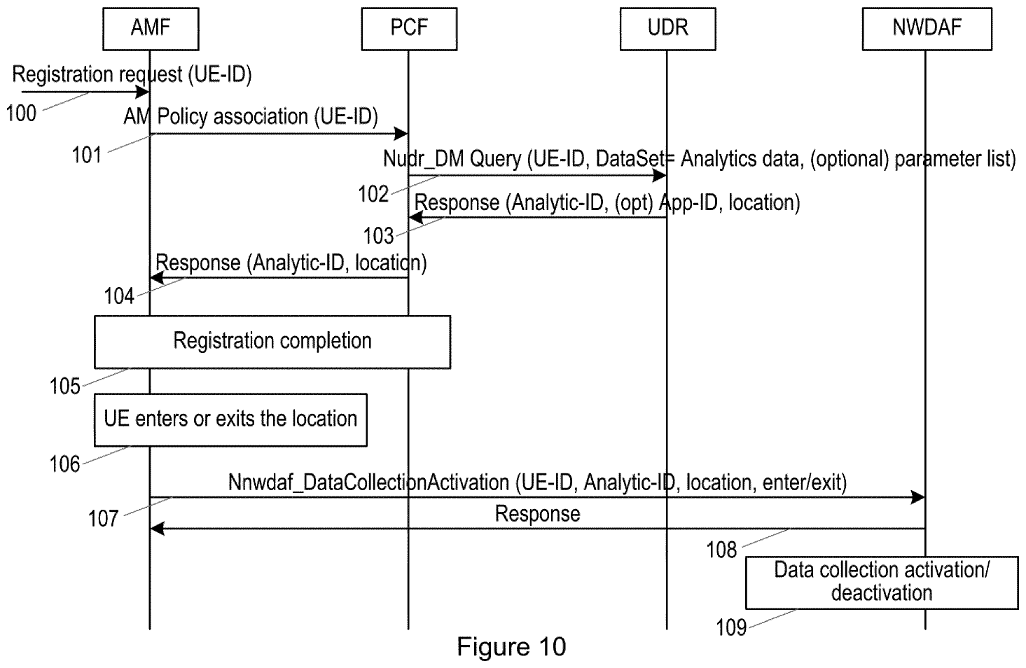

FIG. 10 is a signaling diagram illustrating example steps in a method that may be performed after performing the method of FIG. 9, namely, at a third network function, receiving initiation information corresponding to a UE, and communicating the initiation information to the second network function, communicating from the second network function to the third network function, at least a part of the information relating to an analytic, wherein the at least a part of the information relating to the analytic comprises the at least one analytic criterion, responsive to the UE meeting the at least one analytic criterion, communicating from the third network function to the first network function a request that data collection be activated for the analytic, and activating data collection for the analytic at the first network function.

In this illustrated example, the at least one analytic criterion comprises a location identifier, and it will be appreciated that the AMF is configured to handle location information.

At step 100, the AMF receives a UE registration request from a Radio Access Network (RAN) in which a UE is active. In this illustrated example, the UE registration request comprises the information identifying the user equipment. The RAN may comprise any suitable access node that is able to communicate a registration request identifying the UE. In other words, at a third network function, initiation information corresponding to the UE is received.

At step 101, the AMF sends an Access and Mobility (AM) policy association message to the PCF. In this illustrated example, the message comprises the information identifying the user equipment.

At step 102, the PCF requests the necessary subscription information from the UDR. In this example, the PCF retrieves the subscription data from the UDR by invoking the Nudr_DM Query service operation. In this illustrated example, the Nudr_DM Query service operation comprises information identifying the user equipment (UE-ID), and information identifying the relevant analytics data set stored at the UDR (DataSet=Analytics data). In some embodiments, the Nudr_DM Query service operation may further comprise one or more further parameters to indicate further information to be retrieved from the UDR. For example, the one or more further parameters may indicate that at least one analytic criterion that is associated with the analytic is to be retrieved. In other words, the initiation information is communicated to the second network function.

At step 103, the UDR responds to the request, wherein the response comprises the requested subscription information. In this illustrated example, the response comprises the information identifying the analytic (Analytic-ID), and the at least one analytic criterion that is associated with the analytic (Location). In some embodiments, where no parameter indicating that at least one analytic criterion that is associated with the analytic is to be retrieved is included in the request sent in step 102, the response received at step 103 may instead include all the subscription data that has been stored at the UDR. For example, the response may further comprise the application identifier (App-ID). In other words, at least a part of the information relating to the analytic, wherein the at least a part of the information relating to the analytic comprises the at least one analytic criterion, is communicated from the second network function to the third network function.

At step 104, the PCF responds to the request received in step 101. In this illustrated example, the response comprises the information identifying the analytic (Analytic-ID) and the at least one analytic criterion that is associated with the analytic (Location).

At step 105, the UE registration procedure is completed. As a result of this initialization process described in steps 100-105, the AMF is now configured such that, when the UE fulfils the at least one analytic criterion that is associated with the analytic, the AMF is able to detect this, and request that data collection be activated for the analytic for the UE at the NWDAF.

At step 106, the AMF detects either the entry of, or the exit of, the location represented the at least one analytic criterion by the registered user equipment.

In response to the detection at step 106, at step 107, the AMF requests data collection activation (where the UE has entered the location) at the NWDAF, or alternatively requests data collection deactivation (where the UE has exited the location) at the NWDAF. In this illustrated example, the AMF invokes the Nnwdaf_DataCollectionActivation service in NWDAF. In this illustrated example, the Nnwdaf_DataCollectionActivation service message comprises the information identifying the analytic (Analytic-ID), the at least one analytic criterion that is associated with the analytic (Location), information identifying the user equipment (UE-ID), and a parameter indicating whether the UE has either entered, or exited, the location (enter/exit). The parameter indicating whether the UE has either entered, or exited, the location determines whether data collection is activated, or deactivated, at the NWDAF. In other words, responsive to the UE meeting the at least one analytic criterion, a request that data collection be activated for the analytic is communicated from the third network function to the first network function.

At step 108, the NWDAF acknowledges the data collection activation (or alternatively, data collection deactivation) message.

At step 109, the NWDAF either activates the data collection required for the analytic (if the UE enters the location associated with the analytic) or alternatively, the NWDAF deactivates the data collection required for the analytic (if the UE exits) the location associated with the analytic. In other words, data collection for the analytic is activated at the first network function.

As previously described in outline, the NWDAF may collect data from NFs/AFs based on the services of the AMF, SMF, UDM, PCF, NRF and AF (either directly, or via the NEF). The data may be collected via the Event Exposure Service offered by each NF or AF (as defined in 3GPP TS 23.502 clause 4.15, and clause 5.2), or may be collected via other NF services (for example, Nnrf_NFDiscovery and Nnrf_NFManagement in the NRF as defined in 3GPP TS 23.502 clause 4.17). This data collection service is used directly in order to retrieve behavior data for individual UEs or groups of UEs (for example, UE reachability), and also to retrieve global UE information (for example, the number of UEs present in a geographical area).

Services consumed by the NWDAF for data collection are listed in Table 1:

TABLE 1
services consumed by the NWDAF for data collection.

| | | Reference in 3GPP |
|---|---|---|
| Service producer | Service | TS 23.502 |
| AMF | Namf_EventExposure | 5.2.2.3 |
| SMF | Nsmf_EventExposure | 5.2.8.3 |
| PCF | Npcf_EventExposure | 5.2.5.7 |
| UDM | Nudm_EventExposure | 5.2.3.5 |
| NEF | Nnef_EventExposure | 5.2.6.2 |
| AF | Naf_EventExposure | 5.2 |
| NRF | Nnrf_NFDiscovery | 5.2.7.3 |
| | Nnrf_NFManagement | 5.2.7.2 |

To retrieve data related to a specific UE, the NWDAF first determines which NF instances are serving this UE as stated in Table 2, unless the NWDAF has already obtained this information due to recent operations related to this UE.

TABLE 2
NF Services consumed by the NWDAF to determine
which NF instances are serving a UE.

| NF instance | | | Reference |
|---|---|---|---|
| (serving | NF to be | | in |
| the UE) to | contacted by | | TS 23.502 |
| determine | NWDAF | Service | [3] |
| UDM | NRF | Nnrf_NFDiscovery | 5.2.7.3 |
| AMF | UDM | Nudm_UECM | 5.2.3.2 |
| SMF | UDM | Nudm_UECM | 5.2.3.2 |
| BSF | NRF | Nnrf_NFDiscovery | 5.2.7.3 |
| PCF | BSF | Nbsf_Management | 5.2.13.2 |
| NEF | FFS | | |
| AF | FFS | | |

The UDM instance shall be determined using the NRF thanks to optional request parameters as stated in clause 4.17.4 of 3GPP TS 23.502. The AMF and the SMF instances shall be determined using a request to the UDM providing the Subscription Permanent Identifier (SUFI). To determine the SMF serving a PDU session, the NWDAF shall in addition provide the Data Network Name (DNN) and S-NSSAI of this PDU Session, otherwise the NWDAF will obtain a list of possibly multiple SMFs (for example, one per PDU session). The Binding Support Function (BSF) instance should be discovered using the NRF thanks to optional request parameters (for example, DNN list, IP domain list, IPv4 address range) as stated in clause 4.17.4 of 3GPP TS 23.502.

The PCF instance serving the UE PDU Session(s) should be determined using a request to the BSF request providing the SUPI. To determine the PCF serving a PDU session, the NWDAF should in addition provide the DNN and S-NSSAI of this PDU Session, otherwise the NWDAF will obtain a list of possibly multiple PCFs (for example, one per PDU session).

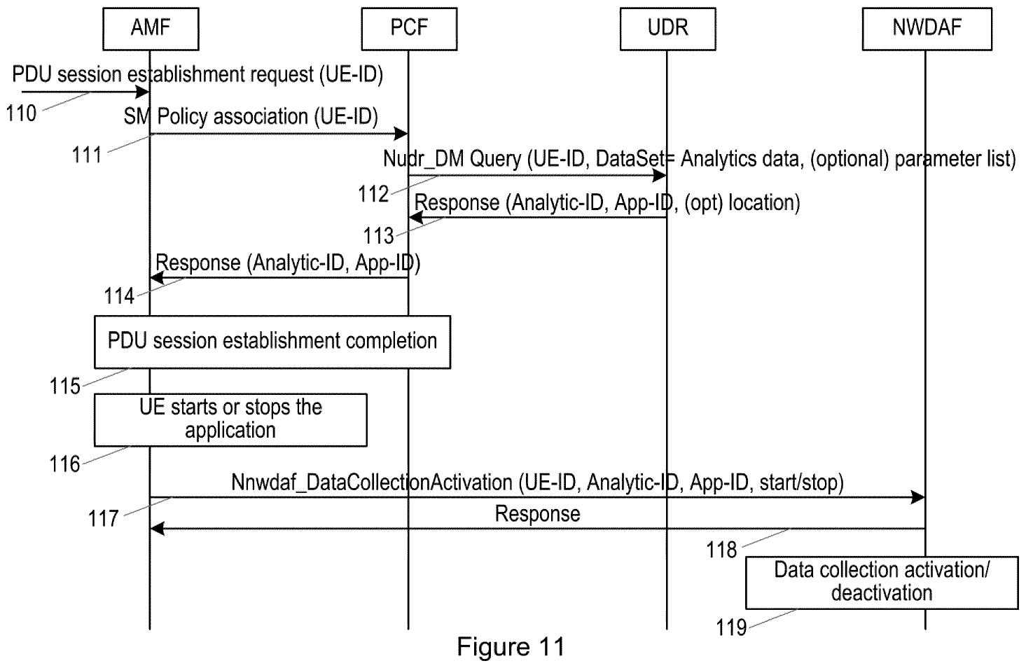

FIG. 11 is a signaling diagram illustrating example steps in an alternative method that may be performed after performing the method of FIG. 9, namely, at a third network function, receiving initiation information corresponding to at least one UE, and communicating the initiation information to a second network function, communicating from the second network function to the third network function, at least a part of the information relating to the analytic, wherein the at least a part of the information relating to the analytic comprises the at least one analytic criterion, responsive to a UE meeting the at least one analytic criterion, communicating from the third network function to the first network function a request that data collection be activated for the analytic, and activating data collection for the analytic at the first network function.

In this illustrated example, the at least one analytic criterion comprises an application identifier, and it will be appreciated that the AMF is configured to handle application execution information.

At step 110, the SMF receives a PDU session establishment request from the AMF. In this illustrated example, the PDU session establishment request comprises the information identifying the user equipment (UE-ID). In other words, at a third network function, initiation information corresponding to the UE is received.

At step 111, the SMF sends a Session Management (SM) policy association message to the PCF. In this illustrated example, the message comprises the information identifying the user equipment (UE-ID).

At step 112, the PCF requests the necessary subscription information from the UDR. In this example, the PCF retrieves the subscription data from the UDR by invoking the Nudr_DM Query service operation. In this illustrated example, the Nudr_DM Query service operation comprises information identifying the user equipment (UE-ID), and information identifying the relevant analytics data set stored at the UDR (DataSet=Analytics data). In some embodiments, the Nudr_DM Query service operation may further comprise one or more further parameters to indicate further information to be retrieved from the UDR. For example, the one or more further parameters may indicate that at least one analytic criterion that is associated with the analytic is to be retrieved. In other words, the initiation information is communicated to the second network function.

At step 113, the UDR responds to the request, wherein the response comprises the requested subscription information. In this illustrated example, the response comprises the information identifying the analytic (Analytic-ID), and the at least one analytic criterion that is associated with the analytic (App-ID). In some embodiments, where no parameter indicating that at least one analytic criterion that is associated with the analytic is to be retrieved is included in the request sent in step 112, the response received at step 113 may instead include all the subscription data that has been stored at the UDR. For example, the response may further comprise the location identifier (Location). In other words, at least a part of the information relating to the analytic, wherein the at least a part of the information relating to the analytic comprises the at least one analytic criterion, is communicated from the second network function to the third network function.

At step 114, the PCF responds to the request received in step 111. In this illustrated example, the response comprises the information identifying the analytic (Analytic-ID) and the at least one analytic criterion that is associated with the analytic (App-ID).

At step 115, the PDU session establishment procedure is completed. As a result of this initialization process described in steps 110-115, the SMF is now configured such that, when the UE fulfils the at least one analytic criterion that is associated with the analytic, the SMF is able to detect this, and request that data collection be activated for the analytic for the UE at the NWDAF.

At step 116, the SMF detects either the beginning of the execution of, or the ending of the execution of, the application represented by the at least one analytic criterion at the registered user equipment.

In response to the detection at step 116, at step 117, the SMF requests data collection activation (where the UE has started executing the application) at the NWDAF, or alternatively requests data collection deactivation (where the UE has stopped executing the application) at the NWDAF. In this illustrated example, the SMF invokes the Nnwdaf_DataCollectionActivation service in NWDAF. In this illustrated example, the Nnwdaf_DataCollectionActivation service message comprises the information identifying the analytic (Analytic-ID), the at least one analytic criterion that is associated with the application (App-ID), information identifying the user equipment (UE-ID), and a parameter indicating whether the UE has either started to execute, or stopped executing, the application (start/stop). The parameter indicating whether the UE has either started to execute, or stopped executing, the application determines whether data collection is activated, or deactivated, at the NWDAF. In other words, responsive to the UE meeting the at least one analytic criterion, a request that data collection be activated for the analytic is communicated from the third network function to the first network function.

At step 118, the NWDAF acknowledges the data collection activation (or alternatively, data collection deactivation) message.

At step 119, the NWDAF either activates the data collection required for the analytic (if the UE starts to execute the application associated with the analytic) or alternatively, the NWDAF deactivates the data collection required for the analytic (if the UE stops executing the application associated with the analytic). In other words, data collection for the analytic is activated at the first network function.

It will be appreciated that the NWDAF may collect data for the production of an analytic via standard mechanisms. It will be appreciated that those skilled in the art will be aware of a number of mechanisms by which the NWDAF may collect data for the production of an analytic. More specifically, the data collection by the NWDAF may be as described above with reference to FIG. 10.

It will be appreciated that the first network function may be configured to activate and/or deactivate data collection in response to a combination of more than one analytic criteria associated with the analytic being fulfilled and/or failing to be fulfilled. For example, the first network function may only activate data collection for an analytic in response to a UE both entering a location that is associated with the analytic, and executing an application that is associated with the analytic.

There is thus described methods and apparatus that enable data collection to be handled more efficiently and effectively in a network.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference signs in the claims shall not be construed so as to limit their scope.

1-58. (canceled)

59. A method of activating data collection for an analytic at a first network function, the method comprising:
registering at the first network function information relating to an analytic, wherein the information relating to the analytic comprises information identifying a user equipment (UE), information identifying the analytic, and at least one analytic criterion that is associated with the analytic;
registering at a second network function the information relating to the analytic;
at a third network function, receiving initiation information corresponding to the UE, and communicating the initiation information to the second network function;
communicating from the second network function to the third network function, at least a part of the information relating to the analytic, wherein the at least a part of the information relating to the analytic comprises the at least one analytic criterion;
responsive to the UE meeting the at least one analytic criterion, communicating from the third network function to the first network function a request that data collection be activated for the analytic; and
activating data collection for the analytic at the first network function.

60. The method of claim 59, wherein the method further comprises:
responsive to the UE no longer meeting the at least one analytic criterion, communicating from the third network function to the first network function a request that data collection be deactivated for the analytic; and
deactivating data collection for the analytic at the first network function.

61. The method of claim 59, wherein the request that data collection be activated for the analytic further comprises the information relating to the analytic.

62. The method of claim 59, wherein the information relating to the analytic from a network server comprising an application function (AF) and is received as part of a subscription request.

63. The method of claim 59, wherein the at least one analytic criterion comprises a location identifier.

64. The method of claim 59, wherein the at least one analytic criterion comprises an application identifier.

65. The method of claim 59, wherein the initiation information corresponding to the UE comprises information identifying the UE.

66. The method of claim 59, wherein the step of registering at the second network function the information relating to the analytic comprises:
receiving, at a network exposure function (NEF), the information relating to the analytic;
communicating from the network exposure function the information relating to the analytic, to the second network function; and
registering at the second network function the information relating to the analytic.

67. The method of claim 59, wherein the step of registering at the second network function the information relating to the analytic comprises:
receiving, at a network exposure function (NEF), the information relating to the analytic;
communicating the information relating to the analytic from the network exposure function to the first network function;
communicating the information relating to the analytic from the first network function to the second network function; and
registering at the second network function the information relating to the analytic.

68. A method of activating data collection for an analytic at a first network function, the method comprising:
registering information relating to an analytic, wherein the information relating to the analytic comprises information identifying a user equipment (UE), information identifying the analytic, and at least one analytic criterion that is associated with the analytic;
receiving, from a third network function, a request that data collection be activated for the analytic; and
activating data collection for the analytic.

69. The method of claim 68, wherein the method further comprises
receiving, from the third network function, a request that data collection be deactivated for the analytic; and
deactivating data collection for the analytic.

70. The method of claim 68, wherein the request that data collection be activated for the analytic further comprises the information relating to the analytic.

71. The method of claim 68, wherein the at least one analytic criterion comprises a location identifier.

72. The method of claim 68, wherein the at least one analytic criterion comprises an application identifier.

73. The method of claim 68, wherein the method further comprises:
communicating the information relating to the analytic to the second network function.

74. A method of operation of a second network function, the method comprising:
registering information relating to an analytic, wherein the information relating to the analytic comprises information identifying a user equipment (UE), information identifying the analytic, and at least one analytic criterion that is associated with the analytic;
receiving, from a third network function, initiation information corresponding to the UE; and
communicating, to the third network function, at least a part of the information relating to the analytic, wherein the at least a part of the information relating to the analytic comprises the at least one analytic criterion.

75. The method of claim 74, wherein the at least one analytic criterion comprises a location identifier.

76. The method of claim 74, wherein the at least one analytic criterion comprises an application identifier.

77. The method of claim 74, wherein the step of registering the information relating to the analytic comprises:
receiving, from a network function for network exposure (NEF), the information relating to the analytic; and
registering the information relating to the analytic.

78. The method of claim 74, wherein the step of registering the information relating to the analytic comprises:
receiving from a first network function the information relating to the analytic; and
registering the information relating to the analytic.
